(19) United States
(12) Patent Application Publication
(10) Pub. No.: US 2017/0116016 A1
(43) Pub. Date: Apr. 27, 2017

(54) SCREEN COMPRESSION SERVICE METHOD AND VIRTUAL NETWORK APPARATUS FOR PERFORMING THE METHOD

(71) Applicant: Electronics and Telecommunications Research Institute, Daejeon (KR)

(72) Inventors: Jong Hwan KIM, Daejeon (KR); Sun Sim CHUN, Daejeon (KR); Kee Seong CHO, Daejeon (KR)

(73) Assignee: Electronics and Telecommunications Research Institute, Daejeon (KR)

(21) Appl. No.: 15/174,351

(22) Filed: Jun. 6, 2016

(30) Foreign Application Priority Data
Oct. 23, 2015 (KR) 10-2015-0148202

(51) Int. Cl. G06F 9/455; H04L 29/06; H04L 29/08

(52) U.S. Cl. CPC G06F 9/45558; H04L 67/10; H04L 67/2809; H04L 67/025; H04L 69/04; G06F 2009/4557; G06F 2009/45595

(57) ABSTRACT

Provided are a screen compression service method and a virtual network apparatus performing the method. Specifically, the screen compression service method relates to a method which compresses a remote screen of a virtual machine remotely accessed through a virtual network apparatus of a network function virtualization (NFV) infrastructure separate from a cloud infrastructure where the virtual machine runs, and transmits the compressed remote screen to a user device.

### CROSS-REFERENCE TO RELATED APPLICATION

This application claims the priority benefit of Korean Patent Application No. 10-2015-0148202, filed on Oct. 23, 2015, in the Korean Intellectual Property Office, the disclosure of which is incorporated herein by reference.

### BACKGROUND

1. Field of the Invention

Embodiments relate to a screen compression service method and a virtual network apparatus performing the method, and more particularly to a service method and an apparatus for efficiently providing a remote screen of a virtual machine remotely accessed.

2. Description of the Related Art

As active use of cloud technology by users leads to commercialization of cloud technology in reality, a virtual desktop infrastructure (VDI) based on a cloud virtualization platform is actively used.

Here, the VDI refers to a desktop service using a desktop virtualization-adopted virtual machine, instead of a user using a personal desktop or office desktop as actual physical hardware. That is, the user accesses a remote server for controlling the virtual machine and is provided with a screen running on the virtual machine through the VDI, thus being provided with the same service as if through a own desktop.

Here, the VDI performs modification and extension of a remote connection server function in order to achieve higher-quality services. However, when the VDI uses server resources by the remote connection server function and is unable to manage server resources used for transmission of a remote screen or implements the server resources in a hypervisor, there are a great number of restrictions in modifying and updating a service function.

To solve such problems, a screen transmission network function virtualization method (virtual network function (VNF)) based on network function virtualization (NFV) is suggested in recent years. The VNF is a technique for running a large number of programs, run in conventional servers, in a virtual machine to efficiently control and manage resources.

The VNF has no problem in providing services when applications dependent mainly on a central processing unit (CPU) or memory are run in virtual machines. On the contrary, when network devices, for example, a switch, a router and a firewall, using a great amount of network traffic and employing dedicated hardware for high-speed packet processing run in virtual machines, network performance is unsatisfactory and limited, and thus it is almost impossible to achieve the VNF.

However, as techniques for high-speed traffic processing in virtual machines as in actual physical network apparatuses are developed with advancement of network virtualization, virtualization of an entire network apparatus are being attempted. However, the developed techniques are for internal processing in virtual machines, while techniques for external processing are insufficient or studies on external processing may not yet be conducted.

Thus, there is a need for a VNF for remote use of a virtual machine running on a cloud infrastructure.

### SUMMARY

An aspect provides a screen compression service method for solving a problem in modifying and updating a server resource or service function which occurs in a virtual desktop service.

Another aspect also provides a screen compression service method for accessing a virtual machine running in a cloud infrastructure and efficiently transmitting a remote screen of the virtual machine remotely accessed to a user device.

According to an aspect, there is provided a screen compression service method performed by a virtual network apparatus, the method including receiving identification (ID) information on at least one virtual machine to remotely access from a user device, determining at least one screen compression component corresponding to each of the virtual machines based on the ID information, compressing a remote screen of each of the virtual machines using the determined screen compression component, and transmitting the compressed remote screen to the user device.

The determining may include determining at least one screen compression component corresponding to the virtual machines in view of a location of a cloud infrastructure in which the virtual machine runs according to the received ID information.

The determining may include determining at least one screen compression component corresponding to the virtual machines through a broker component operating as a slave type when a broker component determining the screen compression component operates as a master type.

The broker component operating as the slave type may determine a screen compression component suitable for the ID information among screen compression components linked with the broker component as the slave type according to a request from the broker component operating as the master type.

The broker component operating as the master type may determine a screen compression component suitable for the ID information among screen compression components linked with the broker component operating as the master type when no screen compression component is determined by the broker component operating as the slave type.

The determining may include determining the same number of screen compression components as a number of pieces of ID information on the at least one virtual machine received from the user device.

The compressing may include: receiving a screen broker request for the virtual machine corresponding to the at least one determined screen compression component; accessing the virtual machine corresponding to the screen compression component in accordance with the screen broker request; and compressing the remote screen of each of the virtual machines.

The virtual network apparatus may include an internal interface enabling internal communication or an external interface enabling external communication to allow access to a virtual machine running in a cloud infrastructure.

The external interface may show a flexible internet protocol (IP) address for access at a shortest distance in view of locations of the virtual machine running in the cloud infrastructure and the virtual network apparatus.

### BRIEF DESCRIPTION OF THE DRAWINGS

These and/or other aspects, features, and advantages of the invention will become apparent and more readily appreciated from the following description of embodiments, taken in conjunction with the accompanying drawings of which:

FIG. 1 illustrates a network function virtualization (NFV) infrastructure linked with a cloud infrastructure according to an example embodiment;

FIG. 2 illustrates a detailed configuration of a virtual network apparatus included in an NFV infrastructure according to an example embodiment;

FIG. 3 illustrates an operation of allocating a virtual network apparatus to a user in view of a location of a virtual machine according to an example embodiment;

FIG. 4 is a flowchart illustrating an operation of updating state information on a screen compression component according to an operation state (master or slave state) of a broker component according to an example embodiment;

FIG. 5 is a flowchart illustrating a procedure for providing a screen compression service through a user device according to an example embodiment;

FIG. 6 is a flowchart illustrating an extended concept of part of operations of the screen compression service of FIG. 5 according to an example embodiment;

FIG. 7 illustrates an access request procedure of a user device which requests remote access to a virtual machine according to an example embodiment;

FIG. 8 illustrates a form of communication between a virtual machine and a virtual network apparatus through an internal host according to an example embodiment;

FIG. 9 is a flowchart illustrating an operation in which a virtual machine is connected to an outside through a virtual switch according to an example embodiment; and

FIG. 10 illustrates a flexible IP address for access at a shortest distance in view of locations of a virtual machine and a virtual network apparatus according to an example embodiment.

### DETAILED DESCRIPTION

Hereinafter, example embodiments will be described in detail with reference to the accompanying drawings.

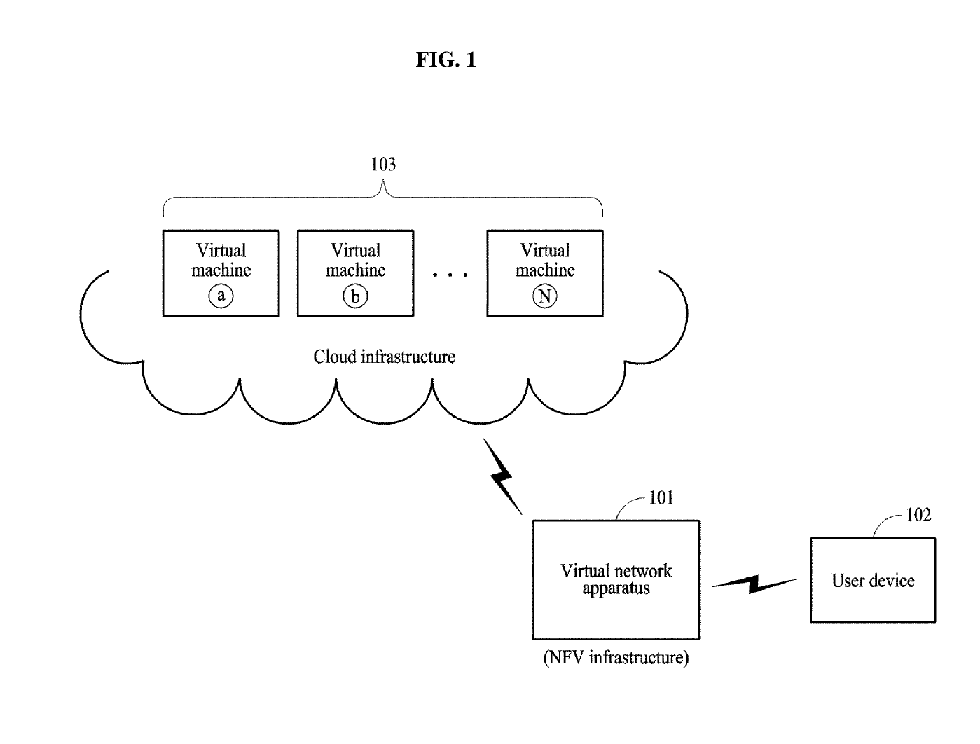

FIG. 1 illustrates a network function virtualization (NFV) infrastructure linked with a cloud infrastructure according to an example embodiment.

Referring to FIG. 1, a virtual network apparatus 101 is connectable to a virtual machine 103 running in the cloud infrastructure. Here, the virtual network apparatus 101 may be configured as one part of an NFV framework. The virtual network 101 may be installed in the NFV infrastructure present separately from the cloud infrastructure. That is, the virtual network apparatus 101 may be configured as one part of the NFV framework and be installed in the NFV infrastructure.

The virtual network apparatus 101 may perform the following operations between the virtual machine 103 located in the cloud infrastructure and a user device 102. The virtual network apparatus 101 may access the virtual machine 103 and receive a remote screen of the accessed virtual machine 103, instead of the user device 102. Further, the virtual network apparatus 101 compresses the received remote screen of the virtual machine 103 and transmits the remote screen to the user device 102, so that a user is provided with a service as if provided on the user device 102.

Specifically, the virtual network apparatus 101 may receive identification (ID) information on at least one virtual machine 103 for the user device 102 to remotely access from the user device 102 to access the virtual machine 103. Here, the ID information on the virtual machine 103 may include a serial number of the virtual machine, an address of a location of the virtual machine, and an address of a location of the cloud infrastructure where the virtual machine is located.

The virtual network apparatus 101 may determine a screen compression component to access the virtual machine 103 corresponding to the received ID information. Here, the screen compression component is a component realized based on screen transmission NVF, which may refer to a virtual application as software. That is, the screen compression component may be a component operating as software via virtualization of a hardware configuration into a software configuration.

The virtual network apparatus 101 may determine at least one screen compression component corresponding to at least each one virtual machine 103. In detail, the virtual machine 103 may operate through one virtual machine 103 or a plurality of virtual machines 103 according to attributes of content to be run by the user. Thus, the virtual network apparatus 101 may identify the at least one virtual machine 103 to remotely access based on the ID information on the virtual machine 103 received from the user device 102. The virtual network apparatus 101 may determine a screen compression component to access instead of the user device 101 corresponding to the at least one identified virtual machine 103.

Subsequently, the virtual network apparatus 101 may compress remote screens of the respective virtual machines via the determined screen compression components. That is, the virtual network apparatus 101 may access the respective virtual machines through the determined screen compression components and receive the remote screens from the respective virtual machines. The virtual network apparatus 101 may compress the remote screens using the screen compression components and transmit the compressed remote screens to the user device.

Ultimately, the virtual network apparatus 101 may be installed in the NFV infrastructure managed independently of the cloud infrastructure and serve as a broker with respect to a remote screen between the user device 102 and the virtual machine 103. That is, in the present embodiment, the remote screen of the virtual machine 103 is not compressed in the cloud infrastructure, but the virtual network apparatus 101 is formed as an independent configuration to provide the user with a screen acceleration service with respect to the remote screen of the virtual machine 103. That is, the virtual network apparatus 101 may be implemented in accordance with a modularization specification of the NFV framework to compress the entire remote screen of the virtual machine 103 into a video stream and provide the compressed video stream to the user device.

Further, the virtual network apparatus 101 may be standardized according to the modulation specification of the NFV framework to facilitate extension of service functions and service management with respect to the virtual machine. In detail, the virtual network apparatus 101 receives the remote screen of the virtual machine from the cloud infrastructure to operate as if the virtual network apparatus 100 is a remote server. Here, the virtual network apparatus 101 relays not only the remote screen but also sounds and data from a keyboard or a mouse according to a protocol of the cloud infrastructure where the virtual machine 103 is located so that the user device 102 smoothly provides the remote screen of the virtual machine 103.

The virtual network apparatus 101, which operates like a remote server as mentioned above, may add a separate service function available in the NFV infrastructure when compressing the remote screen, thereby extending the service functions for the virtual machine. That is, the virtual network apparatus 101 may be established as an independent NFV infrastructure system to provide the user device with the remote screen of the virtual machine in a form of a virtual network function (VNF) suitable for the NFV framework. Ultimately, the virtual network apparatus 101 may make a screen transmission service for a virtual desktop infrastructure (VDI) into a VNF.

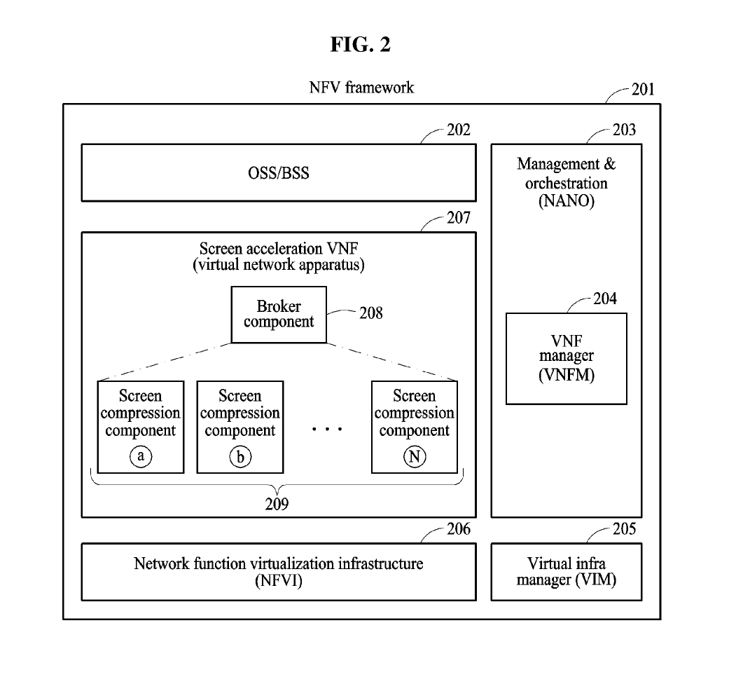

FIG. 2 illustrates a detailed configuration of a virtual network apparatus included in an NFV infrastructure according to an example embodiment.

Referring to FIG. 2, the virtual network apparatus 207 (screen acceleration (SA) VNF) may be configured as one part of an NFV framework 201, as described in FIG. 1. Hereinafter, the virtual network apparatus 207 will be described along with components of the NFV framework 201 in order to illustrate a flow of operations of the virtual network apparatus 207.

The NFV framework 201 may include an operating support system/business supporting system (OSS/BSS) block 202, an management & orchestration (MANO) 203, a VNF manager (VNFM) 204, a virtual infrastructure manager (VIM) 205, an NFV infrastructure (NFVI) 206, and the virtual network apparatus 207. Here, the components (blocks) of the NFV framework 201 are peripheral system functions, which are linked with the virtual network apparatus 207, are defined in the same ETSI NVF standards as for the virtual network apparatus 207, and interfaces between the blocks may provide control and management functions defined in the standards.

The VNFM 204 may manage and control the virtual network apparatus 207. Here, the VNFM 204 may operate under control of the management & orchestration (MANO) 203, and an administrator may manage the entire NFV infrastructure through the management & orchestration (MANO) 203. Further, the VNFM 204 may serve as a broker managing the virtual network apparatus 207 in each NFV framework 201 included in the NFV infrastructure.

The NFVI 206 may provide a virtualization resource like a conventional cloud infrastructure, and the VIM 205 may control the NFVI 206 and serve as a broker to perform a resource control function required by the MANO.

The OSS/BSS block 202 performs operations of a conventional operating support system/business supporting system, and the virtualized VNF network apparatus is ultimately treated the same as a conventional physical network apparatus and thus may be controlled by the OSS/BSS as in conventionally.

The virtual network apparatus 207 may include a broker component 208 and screen compression components 209. Generally, each component of the virtual network apparatus 207 in the NFV infrastructure may individually be implemented through each one container.

Likewise, the broker component 208 and the screen compression components 209 of the virtual network apparatus 207 according to the present embodiment may be implemented in each one container. Further, the container is realized through a virtual machine, which may mean that each container may be implemented in each virtual machine. However, the containers used for the broker component 208 and the screen compression components 209 of the virtual network apparatus 207 may be a container having a virtual resource in a different form from a virtual machine.

The virtual network apparatus 207 according to the present embodiment may operate as follows based on the components of the NFV framework 201.

*Screen Compression Component

The screen compression components 209 may access a virtual machine running in a cloud infrastructure instead of a user device when a user wishes remote access to the virtual machine. The screen compression components 209 may receive a remote screen of the virtual machine, instead of the user device, and compress the received remote screen to transmit to the user device. That is, the screen compression components 209 may practically perform a function of compressing the remote screen of the virtual machine. Here, the screen compression components 209 may relay not only the remote screen of the virtual machine but also sounds and data from a keyboard or a mouse according to a protocol of the cloud infrastructure where the virtual machine is located.

When there are an increasing number of requests from user devices to remotely access the virtual machine, the screen compression component 209 may need to more frequently access the virtual machine to broker the remote screen in real time. In view of this condition, a number of screen compression components 209 may be increased from 1 to N or decreased from N to 1 corresponding to a number of requests from user devices.

Ultimately, the number of screen compression components 209 may dynamically be increased or decreased, and scale-out and scale-in functions may be defined as a scaling operation. The scaling operation may be performed when the VIM 205 controls the NFVI 206 according to a request from the MANO, and the request from the MANO may be implemented by a direct command from an operator or a request from the virtual network apparatus 207 to the VNFM.

*Broker Component

When a plurality of screen compression components 209 is implemented, the broker component 208 may serve to manage and broker the screen compression components.

Specifically, when a user intends to gain remote access to a virtual machine, the broker component 208 may access a user device and receive ID information on the virtual machine to remotely access from the user device. When a compression service request with respect to a remote screen of the virtual machine is made from the user device, the broker component 208 may determine a screen compression component 209 to actually compress the remote screen of the virtual machine and to transmit the remote screen to the user device according to the compression service request. The broker component 208 may transmit the determined screen compression component 209 to the user device.

Subsequently, the user device may be connected to the screen compression component 209 from the broker component 208 and be provided with a compression service with respect to the remote screen of the virtual machine from the connected screen compression component 209.

The broker component 208 may not only serve as a broker between the user device and the screen compression component 209 but also perform management operations, such as execution, setup, control, and monitoring, of the screen compression component.

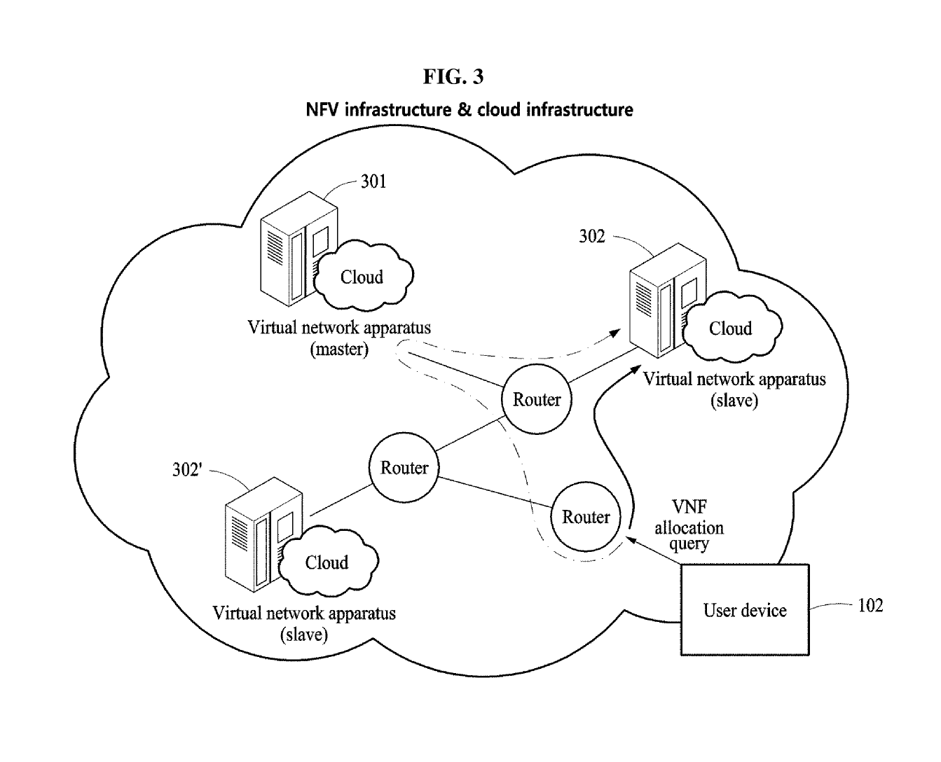

FIG. 3 illustrates an operation of allocating a virtual network apparatus to a user in view of a location of a virtual machine according to an example embodiment.

Referring to FIG. 3, virtual network apparatuses 301, 302, and 302′ may be run in an NFV infrastructure. A plurality of NFV infrastructures may be present. For example, the virtual network apparatuses 301, 302, and 302′ may be installed in a data center where a cloud infrastructure and the NFV infrastructure are installed. Here, a plurality of data centers 301, 302, and 302′ may be distributed in a plurality of regions, in which case virtual networks may be installed in all of the distributed regions. Thus, the virtual network apparatuses 301, 302, and 302′ may be operated in a distributed manner.

The virtual network apparatuses 301, 302, and 302′ may determine at least one screen compression component corresponding to a virtual machine in view of a location of the cloud infrastructure where the virtual machine is run according to received ID information. That is, according to the present embodiment, a virtual network apparatus 301, 302, or 302′ which is located in the same data center where a virtual machine requested by a user device 102 is run or is located in a closest region to the data center may be allocated to the user device 102.

To this end, in the present embodiment, operations of the virtual network apparatuses are divided in to a master type 301 and slave types 302 and 302′, thereby determining a suitable screen compression component according to a location of the user device. That is, broker components of the virtual network apparatuses are divided into a master type 301 and slave types 302 and 302′ and perform different operations according to the divided types.

Specifically, the user device may transmit, to a router, a VNF allocation query for remote access to a virtual machine run in the cloud infrastructure. Here, the router may transmit the VNF allocation query to a virtual network apparatus 301 including a broker component operating as a master type (hereinafter “master broker component”) among virtual network apparatuses included in the distributed data centers.

The master-type virtual network apparatus 301 may verify data obtained by monitoring current states of the virtual network apparatuses 302 and 302′ operating as the slave type in the distributed data sensors. Here, verifying the monitored data may mean verifying whether remote screen components included in the virtual network apparatuses 302 and 302′ operating as the slave type are operated or operation states of the remote screen components. The master-type virtual network apparatus 301 may allocate the slave-type virtual network apparatus 302 located in the same region as the virtual machine requested by the user device 102 based on the data and transmit an allocation result to the user device in response.

The user device may access the slave-type virtual network apparatus 302 and be provided with a screen transmission service with respect to a remote screen of the virtual machine from the accessed slave-type virtual network apparatus 302. Here, the virtual network apparatuses 301, 302, and 302′ are operated in the distributed manner, which is for providing a virtual network apparatus close to the user device or the virtual machine, thereby decreasing a network data path and improving performance by reducing possibility of a bottleneck and network delay.

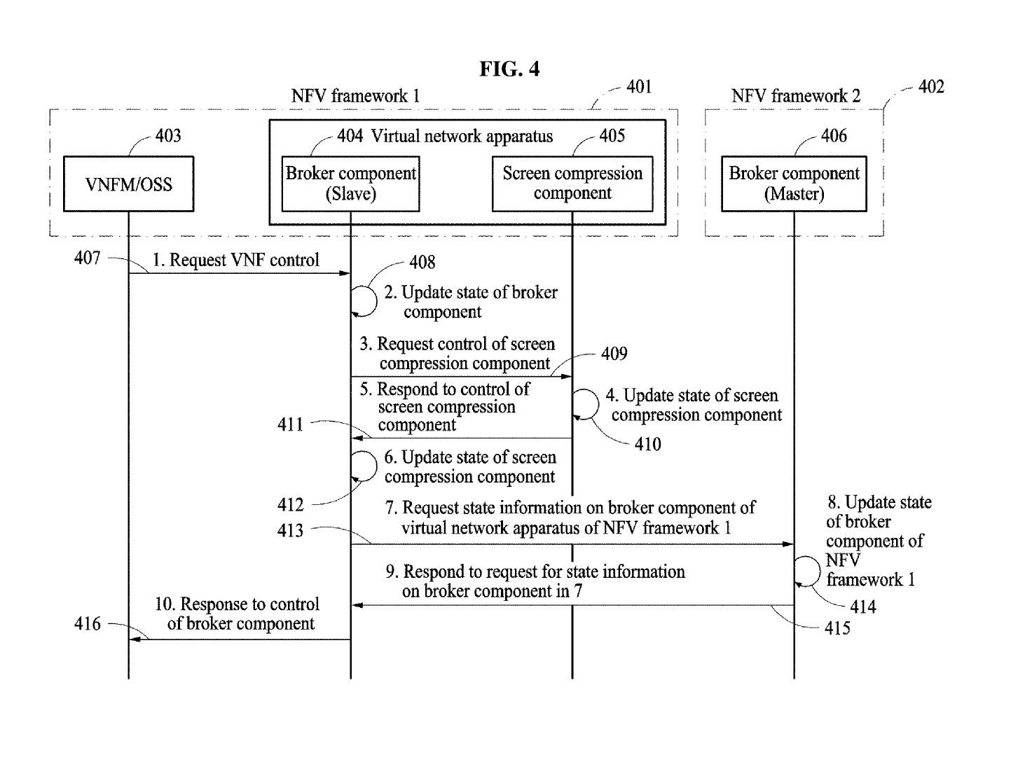

FIG. 4 is a flowchart illustrating an operation of updating state information on a screen compression component according to an operation state (master or slave state) of a broker component according to an example embodiment.

FIG. 4 is a flowchart illustrating an interoperation between NFV frameworks 401 and 402 of NFV infrastructures installed in a distributed manner in a plurality of data centers according to a screen compression service request from a user device. Here, an NFV framework 401 and an NFV framework 402 are components included in NFV infrastructures installed in different data centers and may operate as a master type or slave type according to an operation state of a broker component.

A master broker component may manage slave broker components installed in the plurality of data centers in an integrated manner according to such operations, and a slave broker component may manage a state of a screen compression component of a virtual network apparatus including the slave broker component. To this end, the master broker component may monitor state information on the slave type component, and the slave broker component may monitor and update the screen compression component.

In operation 407, a VNFM/OSS included in NFV framework 1 401 may transmit a control request for controlling a virtual network apparatus to a broker component 404. That is, when a user device transmits a request for remote access to a virtual machine to NFV framework 1 401, the VNFM/OSS of NFV framework 1 401 may transmit the control message transmitted from the user device to the broker component 404 of the virtual network apparatus.

Here, the control message transmitted to the broker component 404 may include messages for installation configuration, initialization, resetting, service configuration, service control (service start, stop, restart), and state monitoring.

In operation 408, the broker component 404 may update an internal state thereof according to requested details included in the control message transmitted from the VNFM/OSS.

In operation 409, the broker component 404 may transmit the control message to the screen compression component managed by the broker component 404 as necessary.

In operation 410, the screen compression component 405 may update an internal state thereof corresponding to the control message received from the broker component 404. Here, the screen compression component 405 may update an internal state of each screen compression component corresponding to a number of screen compression components currently activated.

In operation 411, the screen compression component 405 may transmit a result of updating each internal state to the broker component 404.

In operation 412, the broker component 404 may update the updated internal state of the screen compression component 405.

In operation 413, the broker component 404 may transmit the updated state information on the broker component 404 to a broker component 406 included in NFV framework 2 402. Here, the broker component 404 of NFV framework 1 401 may operate as a slave type, and the broker component 406 of NFV framework 2 402 may operate as a master type. The broker component 404 of NFV framework 1 401 may transmit the updated result to the broker component 406 of NFV framework 2 402 to monitor the state information.

In operation 414, a broker component 406 may update the state information on the broker component 404 of NFV framework 1 401.

In operation 415, the broker component 406 may transmit a result of updating the state information on the broker component 404 of NFV framework 1 401 to the broker component 404.

In operation 416, the broker component 404 may transmit a response to the control message requested in operation 407 to the VNFM/OSS.

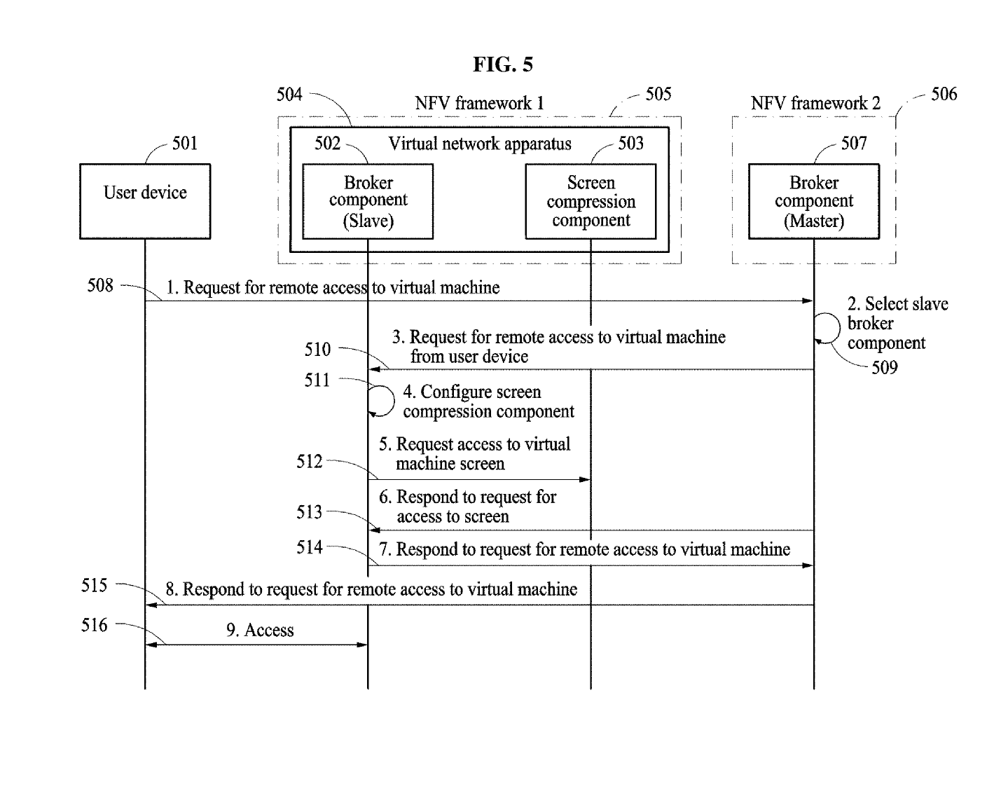

FIG. 5 is a flowchart illustrating a procedure for providing a screen compression service through a user device according to an example embodiment.

FIG. 5 is a flowchart illustrating a process in which a request for remote access to a virtual machine is received from a user device 501 and a screen compression component determined according to the received request is transmitted to the user device 501, thereby providing a remote screen of the virtual machine to the user device 501.

In operation 508, the user device 501 may transmit the request for remote access to the virtual machine to a master broker component 507.

In operation 509, the master broker component 507 may determine a slave broker component 502 corresponding to the request received from the user device 501. Here, the broker component 507 may determine a broker component 502 located in the same data center as a cloud infrastructure or a broker component 502 located adjacently to the virtual machine in view of a location of the cloud infrastructure where the virtual machine for the user device to remotely access is installed.

In operation 510, the master broker component 507 may transmit the request for remote access to the virtual machine remote from the user device 501 to the determined slave broker component 502. That is, the broker component 507 may request service allocation with respect to a screen compression component 503 according to the request for remote access to the virtual machine remote from the user device 501.

In operation 511, the slave broker component 502 may verify a state of the screen compression component 503 included in a virtual network apparatus 504. That is, the broker component 502 may verify whether there is a screen compression component 503 capable of operating according to the request for remote access to the virtual machine among screen compression components 503 included in the virtual network apparatus 504.

In operation 512, the slave broker component 502 may request a service from the screen compression component 503 capable of operating according to the request for remote access to the virtual machine.

In operation 513, the screen compression component 503 may transmit a result of allocating the virtual machine to the broker component 502.

In operation 514, the slave broker component 502 may transmit a response to the request for remote access to the virtual machine transmitted in operation 510 to the master broker component 507.

In operation 515, the master broker component 507 may transmit a result including the screen compression component 503 allocated through the slave broker component 502 to the user device 501.

In operation 516, the user device 501 may access the screen compression component 503 through the slave broker component 502 according to the result transmitted from the broker component 507. The user device 501 may be provided with a screen compression transmission service with respect to the virtual machine to remotely access through the screen compression component 503.

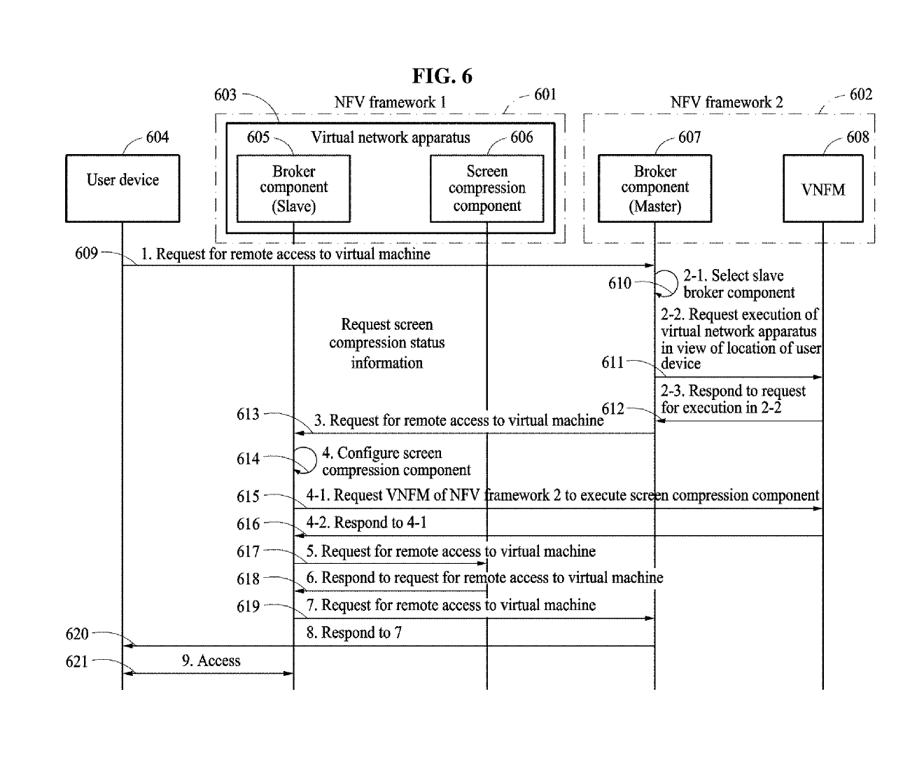

FIG. 6 is a flowchart illustrating an extended concept of part of operations of the screen compression service of FIG. 5 according to an example embodiment.

FIG. 6, associated with FIG. 5, is a flowchart illustrating that when a master broker component 607 does not run a slave broker component 605, the master broker component 607 activates a virtual network apparatus 603 including the master broker component 607, which will be described in operations 609 to 612.

In operation 609, a user device 604 may transmit a request for remote access to a virtual machine to the master broker component 607.

In operation 610, the broker component 607 may verify whether there is a slave broker component 605. Here, the broker component 607 may determine whether there is a virtual network apparatus 603 located adjacently to the virtual machine requested by the user device and determine the virtual network apparatus 603. Here, the broker component 607 may not determine the virtual network apparatus 603 depending on a situation.

That is, in the present embodiment, when the broker component 607 allocates a broker, the virtual network apparatus 603 located adjacently to the virtual machine may not be running. That is, in view of characteristics of a cloud dynamically managed, when no one uses a data center, a virtual network apparatus may not be running in a distributed cloud region. Here, in the present invention, to allocate a virtual network apparatus in the same location as a virtual machine for the user to access is running in the corresponding region, the broker component 607 requests a VNFM 608 to run a virtual network apparatus in the corresponding region in order to allocate a virtual network apparatus present in a corresponding server.

Accordingly, in operation 611, the broker component 607 may transmit, to the VNFM 608, a request for activating a virtual network apparatus located in a data sensor where the virtual machine is present or a virtual network apparatus located in a data sensor adjacent to the virtual machine in view of a location of the virtual machine.

In operation 612, the VNFM 608 may activate a corresponding virtual network apparatus 603 according to the request transmitted from the broker component 607 and transmit an activation result to the broker component 607.

Further, FIG. 6 is a flowchart illustrating that although there is a slave broker component 605, when no screen compression component 606 is determined, the master broker component 607 transmits a request to the VNFM 608 to determine a screen compression component, which will be described with reference to operations 613 to 619.

In operation 613, the broker component 607 may transmit a request for remote access to a virtual machine from a user device 501 to a slave broker component 605.

In operation 614, the slave broker component 605 may verify a state of a screen compression component 606 included in the virtual network apparatus 603. Here, the broker component 605 may not determine the screen compression component 606 according to the request for remote access to the virtual machine, which may occur when all screen compression components 606 included in the virtual network apparatus 603 are currently running or no screen compression component 606 is included in the running virtual network apparatus 603.

In operation 615, the broker component 605 may request the VNFM 608 of NFV framework 2 602 including the master broker component 607 to run the determined screen compression component. That is, the broker component 605 may transmit a request for a scaling operation for determining a screen compression component 606 according to the request for remote access to the virtual machine to the VNFM 608.

In operation 616, the VNFM 608 may transmit a result of the request for the scaling operation to the broker component 605.

In operation 617, the broker component 605 may transmit a request for a service with respect to the request for remote access to the virtual machine from the screen compression component 606 added according to the request for the scaling operation.

In operation 618, the screen compression component 606 may transmit a result of the request for the service to the broker component 605.

In operation 619, the broker component 605 may transmit a response to the request for remote access to the virtual machine transmitted in operation 613 to the master broker component 607.

In operation 620, the master broker component 605 may transmit the response to the request for remote access to the virtual machine transmitted in operation 619 to the user device 604.

In operation 620, the user device 604 may access the screen compression component 606 through the slave broker component 605 according to the result transmitted from the broker component 607.

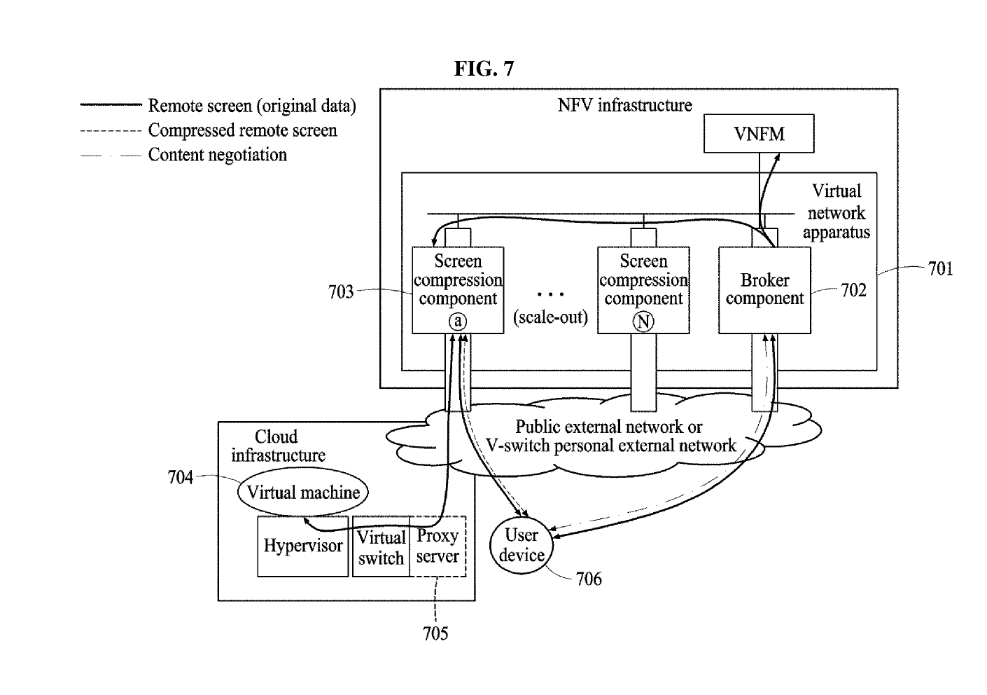

FIG. 7 illustrates an access request procedure of a user device which requests remote access to a virtual machine according to an example embodiment.

Referring to FIG. 7, a user device 706 may be a terminal in which a client program linked with a virtual machine 704 that a user wishes to remotely access runs. The user device 706 may be provided with a remote screen of the virtual machine 704 through the client program from a virtual network apparatus. To this end, the user device 706 may operate as follows.

The user device 706 may access a broker component 702 included in the virtual network apparatus 701 and transmit ID information on the virtual machine 704 for remote access to the virtual machine 704 to the broker component 702.

The broker component 702 may monitor a screen compression component 703 managed by the virtual network apparatus 701 and determine a screen compression component 703 to provide a screen compression transmission service corresponding to the ID information on the virtual machine 704.

The screen compression component 703 may access the virtual machine 704 instead of the user device 706 and receive and compress a remote screen of the accessed virtual machine 704 to transmit the compressed remote screen to the user device 706.

The present embodiment performing the foregoing operations may be defined according to NFV standards, and may define an external communication interface of a virtual network apparatus to provide a VNF. That is, the virtual network apparatus communicates with the external user device 706 and communicates with the cloud infrastructure and thus may define an external communication interface for smooth communications with the user device 706 and the cloud infrastructure.

The virtual network apparatus 701 includes at least two network interfaces. That is, the virtual network apparatus 701 may include an internal interface enabling internal communication or an external interface enabling external communication to allow access to a virtual machine running in the cloud infrastructure.

Specifically, the broker component 702 and the screen compression component 703 included in the virtual network apparatus 701 may be allocated at least one virtual local area network (LAN) to link controls and managements of internal components of an NFV framework forming the virtual network apparatus 701.

Each screen compression component 703 may include at least one internal interface to communicate in the virtual LAN for internal linking. That is, when there is a plurality of virtual machines, remote screens received through screen compression components corresponding to the virtual machines need to be linked, and thus the screen compression components may include at least one internal interface to communicate in the virtual LAN.

The broker component 702 and the screen compression component 703 included in the virtual network apparatus 701 may include at least one external interface to link with the user device 706. Here, the external interface enables external communication with the user device 706 externally located and may include a public IP or a virtual public IP virtually having the same effect as the public IP. For example, the virtual public IP may refer to an OpenStack floating IP.

Hereinafter, a flow of providing a remote screen of a virtual machine to a user device is described based on the aforementioned internal interface and external interface.

A screen compression component may access a virtual machine belonging to a cloud infrastructure externally located in reality. Here, as the screen compression component receives a remote screen (original data which is not compressed) of a virtual machine from the virtual machine, network resources are increasingly consumed, and accordingly screen transmission performance may deteriorate. Thus, the screen compression component according to the present embodiment may allow a network path between the cloud infrastructure where the virtual machine runs and an NFV infrastructure including the screen compression component accessing the virtual machine to have a shortest distance.

That is, the cloud infrastructure and the NFV infrastructure are disposed in the same physical host to directly connect the virtual machine and a virtual network apparatus in which the screen compression component runs. Ultimately, in the present embodiment, the cloud infrastructure of the virtual machine and the NFV infrastructure of the virtual network apparatus are linked to the same infrastructure and connected in an internal LAN, not in a WAN, thereby improving screen transmission performance.

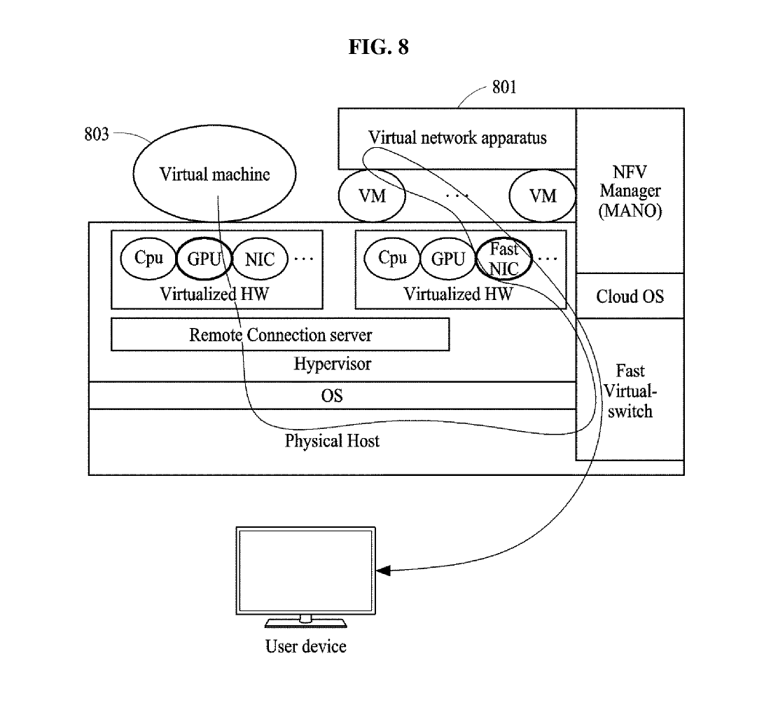

FIG. 8 illustrates a form of communication between a virtual machine and a virtual network apparatus through an internal host according to an example embodiment.

Referring to FIG. 8, a virtual network apparatus 801 may be installed in the same infrastructure as a virtual machine 803 to receive a remote screen of the virtual machine 803 through a shortest path and transmit a compressed remote screen to a user device. That is, the virtual network apparatus 801 and the virtual machine 803 may be allocated to the same server host and thus be allowed to directly communicate via the internal host without traffic escaping externally.

In this case, a remote connection server transmitting the remote screen of the virtual machine 803 and a virtual machine (remote screen component) where the virtual network apparatus runs is directly connected in the internal host, thus minimizing network loads and performance deterioration.

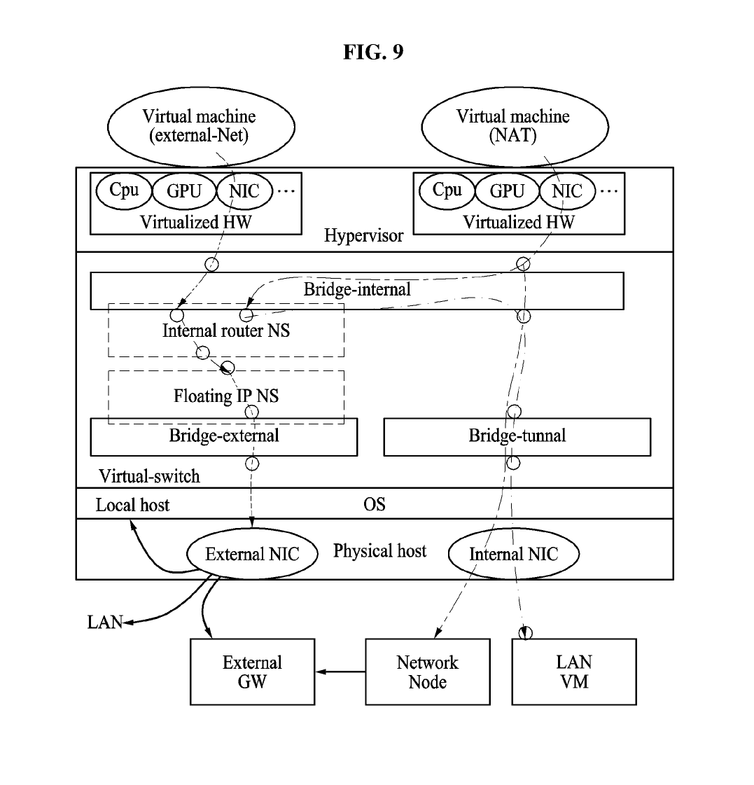

FIG. 9 is a flowchart illustrating an operation in which a virtual machine is connected to an outside through a virtual switch according to an example embodiment.

FIG. 9 illustrates a structure for performing communication with the outside based on a distributed router function of an OpenStack Neutron node as a distributed router function for communication between a virtual network apparatus and a remote connection server in the same host.

That is, virtual machines 901 and 902 illustrated in FIG. 9 may be connected to the outside through a physical network interface card (NIC) of a host through a virtual switch. Here, a right virtual machine 901 has a local network IP using network address translation (NAT) and may be connected to the outside through an internal bridge tunnel through the virtual switch. Here, the right virtual machine 901 has paths to a network node and a LAN VM, and is transmitted to the outside through the network node and thus has no separate communication method with the host.

On the contrary, a left virtual machine 902 may include an external interface enabling direct communication with the outside using a floating IP. In this case, the virtual machine 902 may be connectable to the outside, not only an external GW but also an LAN and local host, based on an external NIC.

Here, since the virtual machine 902 determines routing in a network layer of an external floating IP name space (NS), when the host has the same network LAN IP band as the VM, communication between the virtual machine and the host may be possible. Thus, the present embodiment allows an interface of the virtual network apparatus and an interface of the host to have an interface connected to the same external network LAN in the same form.

Ultimately, when a screen compression component of the virtual network apparatus performs remote access to a virtual machine present in a cloud infrastructure, the screen compression component may access a nearest virtual machine. Here, a service provider may intentionally allocate a screen compression component to the same server host as for the remote virtual machine. The virtual network apparatus may be allocated an external network in a floating IP mode provided by an OpenStack Neutron distributed router in order to communicate with the remote server of the host. Further, the virtual network apparatus may have one virtual interface connected to the currently allocated network. In this case, to enable communication with the host through the interface, one IP in the same external network LAN band may be allocated to the host.

In the present embodiment, in order that a virtual network apparatus (SA VNF) to have optimal performance, the virtual network apparatus may be allocated to the same server host as a virtual machine requested by a user, in which the same screen compression component and the host have the same public IP in a distributed router structure to enable mutual communications.

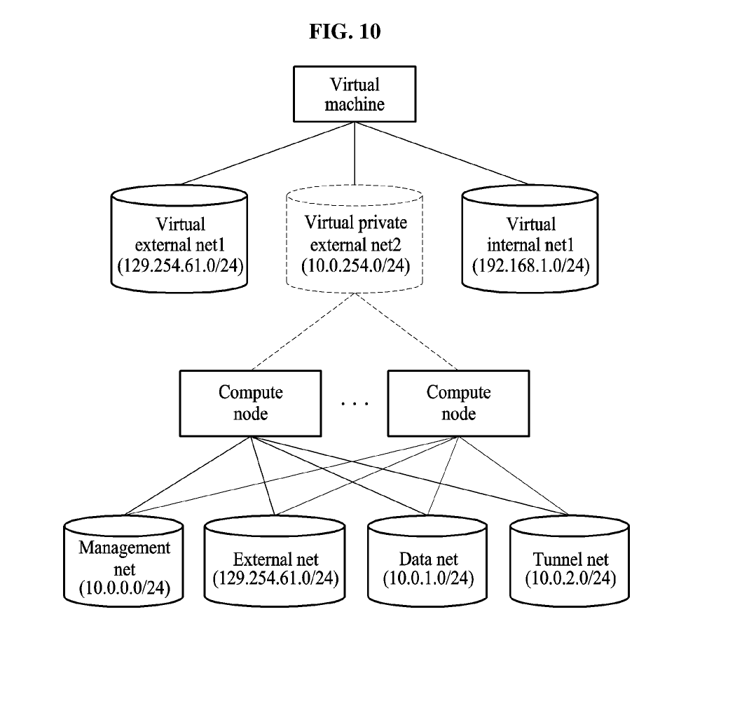

FIG. 10 illustrates a flexible IP address for access at a shortest distance in view of locations of a virtual machine and a virtual network apparatus according to an example embodiment.

FIG. 10 illustrates a flexible IP address secured against a security risk of outside exposure due to external communication between a virtual machine and a virtual network.

That is, in the present embodiment, a virtual machine and a host are allocated the same external network LAN band, which is a 10.x.x.x band as a private IP band where the LAN is not connected to an external Internet. For reference, in the present embodiment, the private IP band allocated by Internet Assigned Numbers Authority (IANA) may be set to the following three bands.

1. 10.0.0.0-10.255.255.255 (10/8 prefix)

2. 172.16.0.0-172.31.255.255 (172.16/12 prefix)

3. 192.168.0.0-192.168.255.255 (192.168/16 prefix)

Here, the private IP band may be available only for communications between internal devices as in a home network and enable communication with a VM without any risk that a host is exposed to external communication.

A screen compression service method according to an embodiment utilizes a screen transmission VNF based on NFV which enables resource control and management, thereby enabling efficient use and management of resources and service based on resource usage.

A screen compression service method according to an embodiment establishes an NFV infrastructure as a separate configuration from a cloud infrastructure and modifies only a virtual network apparatus (SA NFV) of the NFV infrastructure as necessary, thereby facilitating maintenance and repair of the NFV infrastructure.

A screen compression service method according to an embodiment provides a virtual network apparatus based on an NFV infrastructure, thereby facilitating linking with a different VNF having a VNF standard and extension.

The methods according to the example embodiments may be realized as program instructions implemented by various computers and be recorded in non-transitory computer-readable media. The media may include, alone or in combination, the program instructions, data files, data structures, and the like. The program instructions recorded in the media may be designed and configured specially for the present invention or be known and available to those skilled in computer software.

While the present disclosure has been described with reference to a few example embodiments and the accompanying drawings, the present disclosure is not limited to the described example embodiments. Instead, it would be appreciated by those skilled in the art that various modifications and variations can be made from the foregoing descriptions.

Therefore, it should be noted that the scope of the present disclosure is not limited by the illustrated embodiments but defined by the appended claims and their equivalents.

What is claimed is:

1. A screen compression service method performed by a virtual network apparatus, the method comprising:
receiving identification (ID) information on at least one virtual machine to remotely access from a user device;
determining at least one screen compression component corresponding to each of the virtual machines based on the ID information;
compressing a remote screen of each of the virtual machines using the determined screen compression component; and
transmitting the compressed remote screen to the user device.

2. The method of claim 1, wherein the determining comprises determining at least one screen compression component corresponding to the virtual machines in view of a location of a cloud infrastructure in which the virtual machine runs according to the received ID information.

3. The method of claim 1, wherein the determining comprises determining at least one screen compression component corresponding to the virtual machines through a broker component operating as a slave type when a broker component determining the screen compression component operates as a master type.

4. The method of claim 3, wherein the broker component operating as the slave type determines a screen compression component suitable for the ID information among screen compression components linked with the broker component as the slave type according to a request from the broker component operating as the master type.

5. The method of claim 3, wherein the broker component operating as the master type determines a screen compression component suitable for the ID information among screen compression components linked with the broker component operating as the master type when no screen compression component is determined by the broker component operating as the slave type.

6. The method of claim 1, wherein the determining comprises determining the same number of screen compression components as a number of pieces of ID information on the at least one virtual machine received from the user device.

7. The method of claim 1, wherein the compressing comprises:
receiving a screen broker request for the virtual machine corresponding to the at least one determined screen compression component;
accessing the virtual machine corresponding to the screen compression component in accordance with the screen broker request; and
compressing the remote screen of each of the virtual machines.

8. The method of claim 1, wherein the virtual network apparatus comprises an internal interface enabling internal communication or an external interface enabling external communication to allow access to a virtual machine running in a cloud infrastructure.

9. The method of claim 8, wherein the external interface shows a flexible internet protocol (IP) address for access at a shortest distance in view of locations of the virtual machine running in the cloud infrastructure and the virtual network apparatus.
